(19) United States
(12) Patent Application Publication
(10) Pub. No.: US 2023/0391682 A1
(43) Pub. Date: Dec. 7, 2023

(54) PROCESSES FOR FORMING FUNCTIONALIZED MEMBRANES

(71) Applicant: APEX Water Solutions W.L.L, Doha (QA)

(72) Inventors: Andrew R. BARRON, Swansea (GB); Andrius STANULIS, Swansea (GB)

(21) Appl. No.: 18/033,580

(22) PCT Filed: Oct. 26, 2020
(86) PCT No.: PCT/IB2021/059898

§ 371 Date: Apr. 25, 2023

Related U.S. Application Data
(60) Provisional application No. 63/105,371, filed on Oct. 26, 2020.

(51) Int. Cl. C04B 41/46; C04B 35/10; C04B 38/00; C04B 41/45; C04B 41/00; C04B 41/82; B01D 67/00; B01D 69/02; B01D 69/04; B01D 71/02

(52) U.S. Cl. CPC C04B 41/46; C04B 35/10; C04B 38/0054; C04B 41/4554; C04B 41/0072; C04B 41/4515; C04B 41/4535; C04B 41/82; B01D 67/00931; B01D 69/02; B01D 69/04; B01D 71/025; B01D 2323/02; B01D 2323/081; B01D 2323/12; B01D 2323/21826; B01D 2325/02834; B01D 2325/0283

(57) ABSTRACT

Embodiments of the present disclosure generally relate to processes for forming functionalized membranes. In an embodiment, a process for forming a functionalized porous membrane is provided. The process includes introducing a porous membrane with an aqueous solution of a hydrophilic agent in a reaction zone, and operating the reaction zone under conditions to form the functionalized porous membrane, the conditions comprising heating the reaction zone to a temperature of about 95° C. or less.

### BACKGROUND

### Field

Embodiments of the present disclosure generally relate to processes for forming functionalized membranes.

### Description of the Related Art

Separating components, e.g., oil, greases, and biological materials from waste-containing water streams utilizing membranes is important in a variety of industries including the oil and gas industry and the agricultural industry. However, a membrane's capacity to purify or otherwise separate material from the bulk fluid has many drawbacks such as membrane fouling. Membrane fouling refers to the reduction in permeability of the membrane due to, e.g., the accumulation of solids, particulates, and/or other materials on the membrane surface and in the membrane pores. The presence of such solids and clogged pores leads to reduced membrane performance in the form of reduced membrane flux.

Recently, porous membranes that have been functionalized with hydrophilic molecules have been shown to achieve separation of hydrocarbons, as well as increased membrane flux and reduced fouling relative to unfunctionalized membranes. However, conventional methods of forming the functionalized membranes can be inefficient or high in cost.

There is a need for new and improved processes for producing functionalized membranes that overcome one or more deficiencies in the art.

### SUMMARY

Embodiments of the present disclosure generally relate to processes for forming functionalized membranes. The functionalized membranes formed by embodiments described herein can be utilized for, e.g., separating components such as oil, greases, biological materials, and/or other components from waste-containing water streams.

In an embodiment, a process for forming a functionalized porous membrane is provided. The process includes introducing a porous membrane with an aqueous solution of a hydrophilic agent in a reaction zone, and operating the reaction zone under conditions to form the functionalized porous membrane, the conditions comprising heating the reaction zone to a temperature of about 95° C. or less.

In another embodiment, a process for forming a functionalized ceramic membrane is provided. The process includes combining a ceramic membrane and a hydrophilic agent solution in a vessel, the hydrophilic agent solution having a concentration of a hydrophilic agent of about 0.6 mol/L or more. The process further includes reducing a pressure of the vessel for a duration of time effective to remove air from the vessel, and heating the vessel at a temperature from about 80° C. to about 95° C. to form the functionalized ceramic membrane.

In another embodiment, a process for forming a functionalized ceramic membrane is provided. The process includes combining a ceramic membrane and a hydrophilic agent solution in a reactor, the hydrophilic agent solution having a concentration of a hydrophilic agent of about 0.5 mol/L to about 0.7 mol/L. The process further includes reducing a pressure of the reactor for a duration of time effective to at least partially remove air from the reactor, and reacting the ceramic membrane and the hydrophilic agent at a temperature below about 100° C. and for a time of less than about 19 h to form the functionalized ceramic membrane.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a flowchart showing selected operations of an example process for forming a functionalized membrane according to at least one embodiment of the present disclosure.

FIG. 2 is a schematic representation of a cysteic acid functionalized ceramic membrane, with cysteic acid in its neutral and zwitterionic states, according to at least one embodiment of the present disclosure.

FIG. 3 is a schematic representation of an example membrane according to at least one embodiment of the present disclosure.

FIG. 4 shows exemplary data for pH versus concentration of cysteic acid (commercial) and cysteic acid produced from the reaction of cystine with hydrogen peroxide (synthesized).

FIG. 5 shows exemplary data for the pH of an aqueous cysteic acid solution as a function of reaction time with an alumina membrane according to at least one embodiment of the present disclosure.

FIG. 6 shows exemplary data for pH versus concentration of cysteic acid (commercial) and for a 1 mol/L solution of cysteic acid after reaction with two different alumina membranes without replenishing the solution of cysteic acid according to at least one embodiment of the present disclosure.

FIG. 7 shows exemplary data for the increase in water flux for an alumina membrane as a function of the initial cysteic acid solution concentration utilized for functionalization according to at least one embodiment of the present disclosure.

Figures included herein illustrate various embodiments of the disclosure. It is contemplated that elements and features of one embodiment may be beneficially incorporated in other embodiments without further recitation.

### DETAILED DESCRIPTION

Embodiments of the present disclosure generally relate to processes for forming functionalized membranes. Briefly, and in some examples, the process for forming the functionalized membrane includes combining a porous membrane and a hydrophilic agent under conditions to form a functionalized porous membrane. The conditions to form the functionalized membranes include, e.g., shorter reaction times, lower reaction temperatures, and less complexity than state-of-the-art methods for functionalizing membranes. The functionalized membranes formed by embodiments described herein can be utilized for, e.g., separating components such as oil, greases, biological materials, and/or other components from waste-containing water streams such as those water-containing water streams used or produced in, e.g., the oil and gas industry and the agricultural industry.

In contrast to conventional methods, the inventors have found that pre-treatment of the membranes can be omitted prior to combining the membranes with the hydrophilic agent. Here, conventional methods typically pre-treat, or activate, the membrane by utilizing an oxidizing acidic solution or water at elevated temperatures. This pre-treatment operation was performed in order to create hydroxide active species on the surface of the membrane that could react with reactant molecules to form the functionalized membrane. However, pre-treatment of the membrane can actually slow down the reaction to form the functionalized membrane. Embodiments described herein enable functionalization of membranes without such pre-treatment and cleaning operations. By omitting pre-treatment and/or cleaning operations, the reaction time required for the functionalization process as well as costs associated with such pre-treatment and/or cleaning operations is significantly decreased.

In addition, the inventors found that a greater mass of hydrophilic agent (e.g., cysteic acid) could be reacted with membranes even without the hydration or oxidation pre-treatments. Because more hydrophilic agent can be reacted with the membrane, the resulting functionalized membrane shows a higher flux. In some examples, the functionalized membranes made by processes described herein have an increased membrane flux (or water flux) of about 20% or more relative to conventional membranes. Further, the overall process time for forming the functionalized membranes is substantially reduced relative to conventional methods. In some examples, the process time is reduced to about 19 h or less (or even 12 h or less), whereas process times of conventional methods are typically at least 72 h. This represents substantial time and cost savings. In contrast to conventional methods that utilize post-treatment membrane washes at elevated temperatures and/or washing the membrane with water until the pH of the water reaches a specific level, processes described herein can utilize a simple ambient temperature wash.

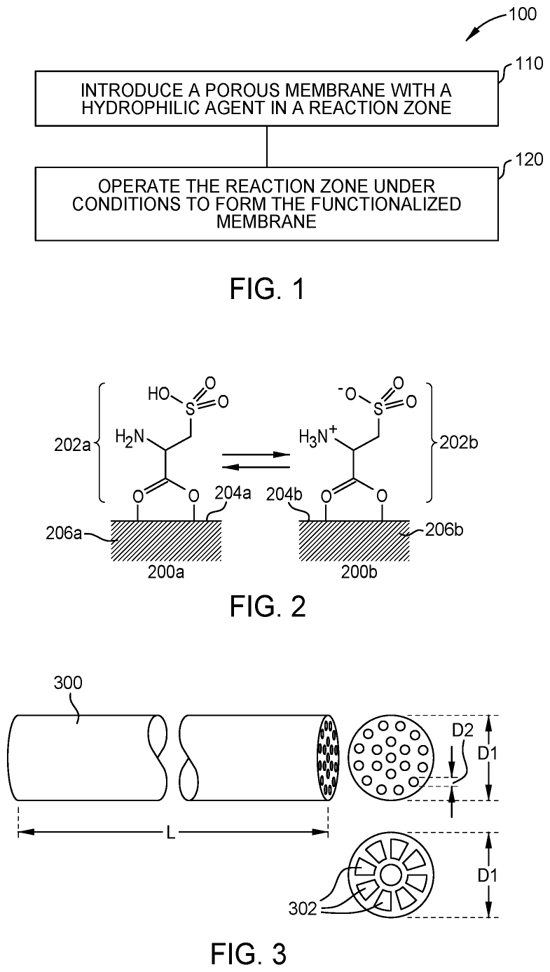

FIG. 1 is a flowchart showing selected operations of an example process 100 for forming a functionalized membrane according to at least one embodiment of the present disclosure. The process 100 includes introducing or combining a porous membrane with a hydrophilic agent. Here, the porous membranes are functionalized using one or more hydrophilic agents. Functionalization of the porous membrane allows for changes in the wettability of the membrane surface as well as changes in the membrane flux. Illustrative, but non-limiting examples, of hydrophilic agents include carboxylic acids, acidic molecules, basic molecules, zwitterionic molecules, phenyl amines, phenyl amidines (e.g., 1,3-diphenylamidine), amino pyridines (e.g., methylaminopyridine), and combinations thereof. In some embodiments, the carboxylic acid has the general formula RCO₂H, where R is a hydrophilic functional group. Illustrative, but non-limiting, examples of carboxylic acids include cysteic acid (also known as 3-sulfo-L-alanine), 3,5-diiodotyrosine, trans-fumaric acid, malonic acid, octanoic acid, stearic acid, 3,5-dihydroxybenzoic acid, para-hydroxybenzoic acid, glycine, derivatives thereof, and combinations thereof. The structure of these carboxylic acids are:

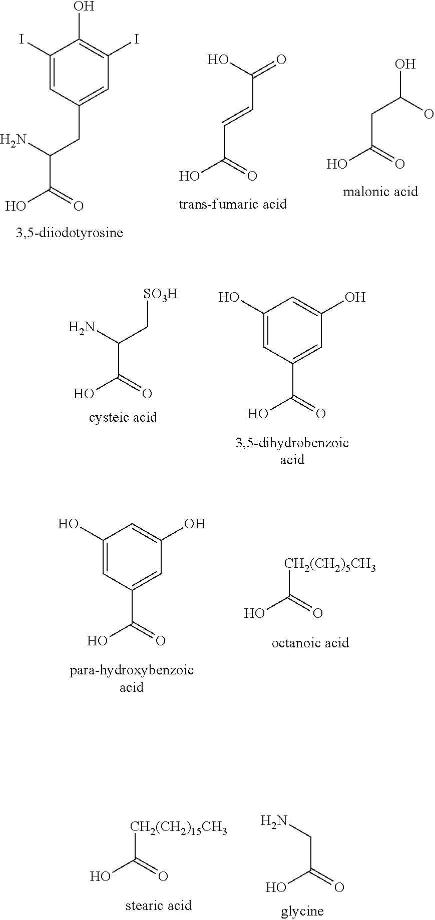

The hydrophilic agent can be in the form of a solution, such as an aqueous solution. This solution containing a hydrophilic agent is interchangeably referred to as a hydrophilic agent solution. A concentration of the hydrophilic agent in the hydrophilic agent solution can be from about 0.1 mol/L or more and/or about 1.1 mol/L or less, such as from about 0.1 mol/L to about 1 mol/L, such as from about 0.15 mol/L to about 0.95 mol/L, such as from about 0.2 mol/L to about 0.9 mol/L, such as from about 0.25 mol/L to about 0.85 mol/L, such as from about 0.3 mol/L to about 0.8 mol/L, such as from about 0.35 mol/L to about 0.75 mol/L, such as from about 0.4 mol/L to about 0.7 mol/L, such as from about 0.45 mol/L to about 0.65 mol/L, such as from about 0.5 mol/L to about 0.6 mol/L, such as from about 0.5 mol/L to about 0.55 mol/L or from about 0.55 mol/L to about 0.6 mol/L. In at least one embodiment, the concentration of the hydrophilic agent in the hydrophilic agent solution is from about 0.5 mol/L to about 0.7 mol/L, or from about 0.5 mol/L to about 0.65 mol/L. In some embodiments, the concentration of the hydrophilic agent in the hydrophilic agent solution is about 0.5 mol/L or more, such as about 0.6 mol/L or more, and/or about 2 mol/L or less. Higher or lower concentrations of the hydrophilic agent in the hydrophilic agent solution are contemplated. The hydrophilic agent can be in its ionic form (including zwitterionic form) and/or neutral form depending on, e.g., the pH of the hydrophilic agent solution. More than one hydrophilic agent can be used.

Introducing (or combining) the porous membrane with the hydrophilic agent can be performed in a portion (e.g., a reaction zone) of a reactor, vessel, or any other suitable unit for, e.g., small-scale, commercial-scale, or intermediate-scale applications. The reactor, vessel, unit, or reaction zone thereof, can hold a single membrane or multiple membranes. Non-limiting properties of example porous membranes that can be used with process 100 are described below.

After operation 110, a vacuum can be applied to the reactor, the vessel, the unit, or the reaction zone thereof. Applying the vacuum can ensure removal, or substantial removal, of the air from the membrane (e.g., from the pores of the membrane), the hydrophilic agent solution, or both. The vacuum, or reduced pressure, can be applied by using, e.g., a water aspirator, a vacuum pump, or other suitable device for reducing the pressure of the reactor, the vessel, the unit, or the reaction zone thereof. Additionally, or alternatively, N₂, argon (Ar), and/or other non-reactive gases can be introduced to the reactor, vessel, unit, or reaction zone thereof, to, e.g., ensure removal, or substantial removal, of the air from the membrane, the hydrophilic agent solution, or both. The amount of time for applying the reduced pressure can be monitored by observing whether the membrane and/or the hydrophilic agent solution has ceased, or substantially ceased, effervescing. After a suitable amount of time for removal (or otherwise purging) a portion or a substantial portion of the air, operation 120 can begin.

The process 100 can further include operating the reactor, vessel, unit, or a reaction zone thereof, under conditions effective to convert at least a portion of the membrane to a functionalized membrane at operation 120. Suitable conditions include a reaction temperature and a reaction time. The reaction temperature of operation 120 can be about 50° C. or more and/or about 120° C. or less, such as about 60° C. or more and/or about 110° C. or less, such as from about 65° C. to about 105° C., such as from about 70° C. to about 100° C., such as from about 75° C. to about 95° C., such as from about 80° C. to about 90° C., such as from about 80° C. to about 85° C. or from about 85° C. to about 90° C. In at least one embodiment, the reaction temperature of operation 120 can be less than about 100° C., such as less than about 95° C., from about 70° C. to about 95° C., or from about 80° C. to about 95° C. Higher or lower temperatures can be used when appropriate. The reaction temperature of operation 120 can be set to a desired temperature on the reactor, vessel, unit, or a reaction zone thereof. Additionally, or alternatively, the temperature can be monitored, continuously and/or at certain times, such that the temperature of the reactants is equal or substantially equal to one or more of the aforementioned reaction temperatures. The temperature feedback can be used to adjust the reaction temperature of the reaction zone. The reaction time of operation 120 can be about 1 minute (min) or more and/or about 24 h or less, such as from about 5 h to about 24 h, such as from about 6 h to about 23 h, such as from about 7 h to about 22 h, such as from about 8 h to about 21 h, such as from about 9 h to about 20 h, such as from about 10 h to about 19 h, such as from about 11 h to about 18 h, such as from about 12 h to about 17 h, such as from about 13 h to about 16 h, such as from about 14 h to about 15 h. In at least one embodiment, the reaction time of operation 120 can be from about 12 h to about 19 h, such as from about 13 h to about 18 h, such as from about 14 h to about 17 h, such as from about 15 h to about 16 h. The reaction time of operation 120 can be more or less depending on, e.g., the level of conversion desired.

Conditions effective for the reaction between the hydrophilic agent and the porous membrane can include stirring, mixing, and/or agitation. The conditions of operation 120 can optionally include utilizing a non-reactive gas, such as N₂ and/or a noble gas such as Ar. For example, the hydrophilic agent and the porous membrane can be placed under these and/or other non-reactive gases to, e.g., degas various components or otherwise remove oxygen from the reaction zone. Any suitable operating pressure can be utilized for operation 120.

The process can further include optional post-reaction operations such as cooling the membrane (e.g., allowing the membrane to cool to room temperature) as well as washing the membrane. The membrane can be washed with water and/or organic solvent at ambient pressures and temperatures (about 15-25° C.) to remove, e.g., residual reactants.

As an example, a porous membrane and a hydrophilic agent can be disposed within a reactor or a reaction zone thereof. A vacuum can be applied for a suitable period of time to remove at least a portion of the air in the reactor (reaction zone thereof), the membrane, and/or the hydrophilic agent solution. The vacuum can then be turned off. The reaction temperature of the reactor or the reaction zone can then be set to a desired temperature. After a desired level of conversion has been achieved, the functionalized membrane can be cooled and removed from the reactor or a reaction zone thereof. The functionalized membrane can be allowed to cool to a desired temperature (e.g., a temperature less than the reaction temperature, such as room temperature) by reducing the heat applied to the reactor (or reaction zone thereof) and then removed from the reactor or reaction zone thereof. The membrane can then be washed if desired.

As a non-limiting example of a functionalized membrane formed by some embodiments described herein, FIG. 2 shows a cysteic acid functionalized porous membrane. In this example, cysteic acid is used as a hydrophilic agent to react with a porous membrane and form the functionalized porous membrane 200a, 200b. The cysteic acid ligand (in its neutral state 202a), which can exist in equilibria with its zwitterionic state 202b, is bound (chemically and/or physically) through its carboxylate moiety to a surface 204a, 204b of the porous membrane 206a, 206b. Portions of the functionalized membrane formed from processes described herein, and as shown by the non-limiting example of FIG. 2, can exist in its neutral form and/or its ionic form (including zwitterionic form).

In some embodiments, operations 110 and/or operation 120 are repeated for the same membrane. Additionally, or alternatively, the functionalized membrane can be removed from the unit and replaced with an unfunctionalized membrane. This unfunctionalized membrane can be reacted with the same hydrophilic agent solution or a different hydrophilic agent solution. For example, the hydrophilic agent solution containing the hydrophilic agent can be reused until a concentration of the hydrophilic agent in the hydrophilic agent solution is below a threshold concentration, such as below about 1 mol/L, such as below about 0.9 mol/L, such as below about 0.8 mol/L, such as below about 0.7 mol/L, such as below about 0.6 mol/L, such as below about 0.5 mol/L, such as below about 0.4 mol/L, such as below about 0.3 mol/L, such as below about 0.2 mol/L, such as below about 0.1 mol/L. When the concentration of the hydrophilic agent in the hydrophilic agent solution is below the threshold concentration, additional hydrophilic agent (in the form of, e.g., pure or substantially pure hydrophilic agent, a concentrate, or a solution) can be added to the hydrophilic agent solution such that the concentration of hydrophilic agent is above the threshold concentration. Operations 110 and/or operation 120 can be performed on a single membrane or a plurality of membranes.

After the functionalized membrane is formed, the membrane is ready for use in, e.g., filtering wastewater or another feed. The functionalized membrane has improved membrane flux relative to an unfunctionalized porous membrane and/or a functionalized porous membrane that was formed using a pre-treated membrane. In some embodiments, the membrane flux of the membrane increases by about 10% or more, such as about 20% or more, such as about 30% or more, such as about 40% or more relative to an unfunctionalized porous membrane and/or a functionalized porous membrane that was formed using a pre-treated membrane. The membrane flux is the amount of permeate produced per unit area of membrane surface per unit time. The membrane flux is measured in LMH (Liter/m²/h) or GFD (Gallons/ft²/day).

Operations of the processes described herein can be performed with a variety of porous membranes having, e.g., variable sizes, shapes, forms, chemical makeups, surface functionality, etc. For example, the porous membranes can be, or be derived from, aluminum-containing materials (e.g., alumina (Al₂O₃) and/or alumoxane), titanium-containing materials (e.g., titania (TiO₂)), zirconium-containing materials (e.g., zirconia (ZrO₂)), derivatives thereof, or combinations thereof. The use of other ceramic materials, as well as polymeric membranes, are also contemplated. FIG. 3 shows an example porous membrane 300 according to at least one embodiment of the present disclosure. In at least one embodiment, the porous membrane 300 is cylindrical, substantially cylindrical, flat, substantially flat, circular, or substantially circular, though other shapes are contemplated. Additionally, or alternatively, the porous membrane is in the form of nanoparticles, though other forms are contemplated. The length (L) of the porous membrane 300 is also variable. In some embodiments, the porous membrane 300 has a length, L, of about 1 centimeter (cm) or more and/or about 2 meters (m) or less, such as from about 10 cm to about 1.5 m, such as from about 25 cm to about 1 m or from about 12 cm to about 0.5 m. In at least one embodiment, the length, L, of the porous membrane 300 is from about 250 mm to about 1200 mm. Porous membranes having larger or smaller lengths are contemplated. The diameter of the porous membrane 300 (e.g., D1 in FIG. 3) can be about 1 cm or more and/or about 5 cm or less, such as from about 2 cm to about 4.5 cm, such as from about 2.5 cm to about 4 cm, such as from about 3 cm to about 3.5 cm. In some examples, the diameter, D1, of the porous membrane 300 is from about 12 mm (˜1.2 cm) to about 40 mm (4 cm). Larger or smaller diameters D1 of the porous membrane 300 are contemplated. The porous membrane 300 can also include channels 302. The channels 302 can have a channel diameter, D2, of about 1 mm to about 20 mm, such as from about 3 mm to about 16 mm, such as from about 5 mm to about 12 mm, such as from about 8 mm to about 10 mm. Larger or smaller diameters D2 of the porous membrane 300 are contemplated. The number of channels 302 and/or shapes of the channel 302 can also vary. The number of channels can range from about 1 channel to about 250 channels, such as from about 5 to about 225 channels, such as from about 10 to about 150 channels, such as from about 25 to about 100 channels, such as from about 50 to about 75 channels. A higher or lower number of channels is contemplated.

In some embodiments, the pores of the porous membrane 300 can have a diameter from about 0.1 μm to about 10 μm, such as from about 0.1 μm in diameter to about 1 μm in diameter, such as from about 0.14 μm in diameter to about 1.4 μm in diameter. Pore sizes greater than about 10 μm in diameter or less than about 0.1 μm in diameter are also contemplated. In at least one embodiment, the pore diameter is about 0.1 μm to about 5 μm, such as from about 0.5 μm to about 4 μm, such as from about 1 μm to about 3 μm.

In some embodiments, the porous membrane 300 includes one or more layers such as from about 1 to about 10 layers, such as from about 2 to about 8 layers, such as from about 3 to about 7 layers, such as from about 4 to about 6 layers. Porous membranes having a greater number of layers are also contemplated. In some examples, the membrane is a tubular cross-flow membrane.

The aforementioned list of properties of the porous membrane is not intended to limit the scope of the embodiments described herein as the processes described herein can be used with other suitable porous membranes.

Relative to conventional methods, the extent of membrane functionalization can be increased without pre-treatment operations. In some embodiments, the functionalized ceramic membrane has a weight ratio of alumina to hydrophilic agent of about 35:1 to about 45:1, such as from about 37:1 to about 42:1, such as from about 39:1 to about 40:1, based on a starting material weight ratio used for forming the functionalized ceramic membrane. Higher or lower weight ratios are contemplated based on, e.g., the level of conversion desired, membrane pore size (surface area). When the membrane is made of other materials, such as titanium-containing materials, zirconium-containing materials, and/or other aluminum-containing materials, the weight ratios can be similar.

The following examples are put forth so as to provide those of ordinary skill in the art with a complete disclosure and description of how to make and use embodiments of the present disclosure, and are not intended to limit the scope of embodiments of the present disclosure. Further, while the membranes utilized for the examples are cysteic acid functionalized membranes, it will be appreciated that the disclosure may be applied to other membranes functionalized with hydrophilic molecules. In addition, efforts have been made to ensure accuracy with respect to numbers used (e.g. amounts, dimensions, etc.) but some experimental errors and deviations should be accounted for.

### EXAMPLES

### Characterization and Materials

pH and conductivity measurements were performed using Mettler Toledo FiveGo™ Portable F2 pH/mV Meter. Proton Nuclear Magnetic Resonance (¹H NMR) data was obtained on a Bruker AV-500 Avance III™ 500 MHz spectrometer using D₂O as a solvent and dimethyl sulfoxide-d₆ (DMSO-d₆) as an internal standard for concentration calculation.

L-cysteic acid was obtained commercially from Sigma Aldrich (UK) and Shaanxi Greenbo Biochem Co., LTD (China). Additional samples of L-cysteic acid were prepared by the reaction of cystine with hydrogen peroxide. The L-cysteic acid solutions utilizing the commercial L-cysteic acid samples or the synthesized L-cysteic acid were made to selected concentrations by dissolving in water. Alumina ceramic membranes (0.14 μm nominal pore size) were obtained from Atech Innovations Gmbh, Germany.

### Membrane Functionalization

### Example 1

Alumina ceramic membranes (0.14 μm nominal pore size, Atech) were placed in glass reactors which are heated externally. The desired concentration of L-cysteic acid (e.g., about 0.6 mol/L) dissolved in water were added to each reaction vessel. A reduced pressure was applied to each glass reactor to remove air from the pores of the membranes. The temperature of the glass reactors were raised to between about 90° C. and about 95° C. and maintained at this temperature for between about 12 and about 19 hours to form the functionalized membranes. After allowing the functionalized membranes to cool, the functionalized membranes were removed from their respective glass reactors. The functionalized membranes were washed in a water bath with constant water exchange at ambient temperatures and pressures.

### Comparative Example 1 (C.Ex. 1)

One conventional method of forming functionalized membranes, as disclosed in U.S. Pat. No. 9,242,876, utilizes pre-treatment of a membrane in piranha solution (1:1 solution of concentrated sulfuric acid (H₂SO₄) and H₂O₂ (30% (w/w) in H₂O)). After the membrane was immersed in piranha solution for about 15 minutes (min), the membrane was sonicated in deionized water for 30 min, re-immersed in piranha solution for 5 min, and sonicated again in deionized water for 30 min. The pre-treated membrane was then immersed in a 1 mol/L aqueous solution of L-cysteic acid (or other hydrophilic agent) and a vacuum was applied to remove air from the membrane. After the membrane and L-cysteic acid solution ceased effervescing, the membrane and L-cysteic acid solution was refluxed at 120° C. for three days to form the functionalized membrane. The L-cysteic acid solution was removed and the functionalized membrane was washed with deionized water and sonicated in deionized water for 30 min. The functionalized membrane was again washed with deionized water and sonicated in deionized water for 30 min, then washed with acetone, and dried.

Here, pre-treatment with the piranha solution was performed to create hydroxide active species on the surface of the porous membrane. The hydrophilic agent could then react with the hydroxide active species of the porous membrane via carboxylic acid group. Long reaction times (e.g., 74 h) were used to ensure complete reaction of the membrane surfaces and the hydrophilic agent.

### Comparative Example 2 (C.Ex. 2)

A similar method to C.Ex. 1 is disclosed in U.S. Pat. No. 10,286,363 except that the reaction time is 96 h.

### Comparative Example 3 (C.Ex. 3)

An alternative, conventional method is disclosed in Maguire-Boyle et al., Superhydrophilic functionalization of microfiltration ceramic membranes enables separation of hydrocarbons from frac and produced water, Sci. Rep. 7, 12267 (2017). In this method, a porous membrane was placed in an airtight glass container filled with deionized water and placed under vacuum to remove air from the interstitial pores of the porous membrane. After the membrane and deionized water ceased effervescing, the vacuum was removed and the glass container was heated to 85° C. for 24 h, at which point the deionized water was removed from the glass container. The pre-treated membrane was then immersed in a 1 mol/L aqueous solution of L-cysteic acid (or other hydrophilic agent) and a vacuum was applied to remove air from the membranes. After the membrane and L-cysteic acid solution ceased effervescing, the membrane and L-cysteic acid solution was refluxed for 48 hours (h). The membrane was then allowed to cool to room temperature at which point the membrane was again immersed in deionized water and a vacuum is applied. After the membrane and deionized water ceased effervescing, the membrane and water was heated to 50° C. and then then water was drained. This process was repeated 3 times or until the water had a pH of 6. After functionalization, the membranes can be dried using acetone. In this method, the pre-treatment with water was performed to create hydroxide active species on the surface of the porous membrane.

Table 1 shows a summary of results for the example method (Ex. 1) according to at least one embodiment described herein versus various comparative example methods—C.Ex. 1, C.Ex. 2, and C.Ex. 3—for an 8,000 barrel-per-day commercial unit. Total process time was calculated based on the following: In a commercial membrane system for treating produced water at an economically acceptable rate of 8,000 barrels-per-day, there are approximately 480 membranes. It is assumed that that functionalization processes are performed on multiple membranes within a single housing and that a typical housing contains 30 membranes.

TABLE 1

| | | Treatment | | | | |
|---|---|---|---|---|---|---|
| | | L- | | Number | | |
| | | Cysteic | | of | | |
| | | Acid | Treat- | Cycles | Total | Total |
| | Pre- | Concen- | ment | per 30 | Process | Process |
| | Treatment | tration | Time | Membrane | Time | Time |
| Method | Operation? | (mol/L) | (h) | Housings | (h) | (days) |
| Ex. 1 | No | ≥0.6 | 19 | 16 | 304 | 12 |
| C. Ex. 1 | Yes | 1.0 | 74 | 16 | 1184 | 49 |
| C. Ex. 2 | Yes | 0.5 | 96 | 16 | 1536 | 64 |
| C. Ex. 3 | Yes | 1.0 | 72 | 16 | 1152 | 48 |

Table 1 illustrates, e.g., the efficiency of the methods described herein. While Ex. 1 has a treatment time of about 19 h or less, the comparative examples exhibit substantially longer treatment times—over 72 h (C.Ex. 3), over 74 h (C. Ex. 1), or over 96 h (C.Ex. 2). That is, Ex. 1 shows a significant reduction in manufacturing time in terms of treatment time and process time. Here, the treatment time and process time are reduced by more than about 73% when comparing Ex. 1 with C.Ex.3, and by more than about 80% when comparing Ex. 1 to C.Ex. 2. Further, the methods described are free of pre-treatment operations such as hydration and/or oxidation. As described above, pre-treatment operations used in conventional methods required the use of strong acids and oxidizing agents on the membranes followed by extensive washing of the membranes with water. Pre-treatment operations used in other conventional methods included heating the water near or above reflux for 1 or more days prior to functionalization. Such pre-treatment operations represent substantial costs. Because the methods described herein omit such pre-treatment operations, substantial cost savings can be realized.

A further disadvantage of the state-of-the-art is the complex handling requirements for piranha solution and acetone. Moreover, the pre-treatment operations on the membranes, such as heating the membranes in water under vacuum, adds complexity to the process, thereby increasing processing time and manufacturing costs. In contrast, embodiments described herein are less complex and require less processing time.

### Uptake of Cysteic Acid

The uptake of L-cysteic acid by membranes was investigated to determine, e.g., suitable concentrations of hydrophilic agent solutions to utilize for membrane functionalization. The ¹H NMR studies of synthesized L-cysteic acid showed that the reaction yield is about 66-70%. Thus, preparing a nominal 1 mol/L solution based upon the reactants means that a 0.66-0.70 mol/L solution is obtained. Based on the NMR results, using DMSO as a standard, it was found that ˜1.00 g of Al₂O₃ membrane uptakes about 0.023 g of L-cysteic acid (synthesized), when a ˜0.66 mol/L cysteic acid solution is used (110.4 g/membrane).

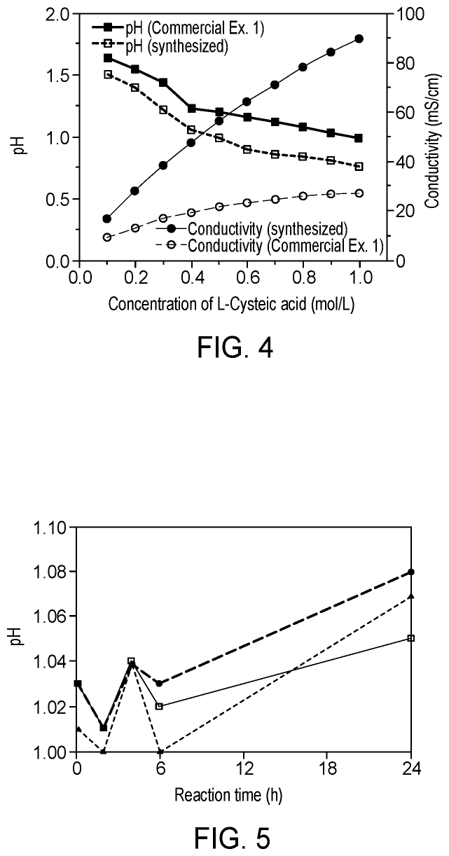

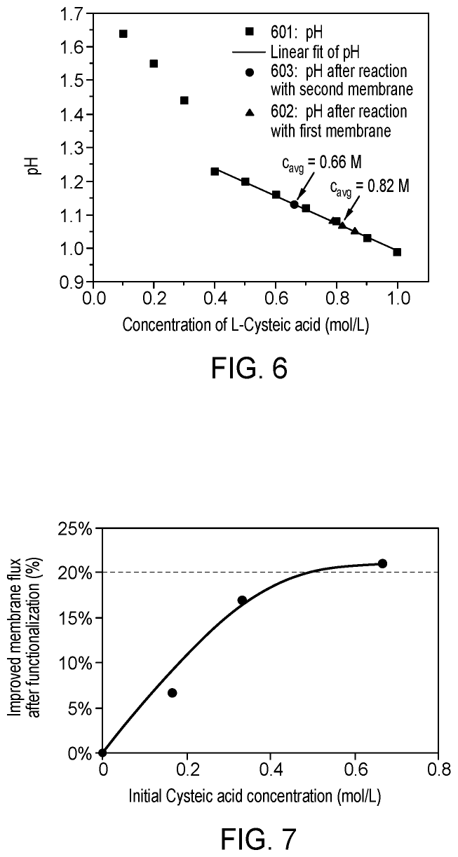

The L-cysteic acid purchased from Greenbo Biochem (commercial Ex. 2) seems to be a monohydrate, due to good solubility. The uptake of L-cysteic acid (commercial Ex. 2) was determined using pH plot for L-cysteic acid (commercial Ex. 1) in FIG. 4 as a guideline (black squares). FIG. 6 shows the pH change after reaction with first (triangle) and second (circle) membranes in the same reactor. After the first use the concentration of starting L-cysteic acid solution (commercial Ex. 2) decreased from 1 M to 0.82 M. Based on pH results, it was found that ˜1.00 g of Al₂O₃ membrane uptakes about 0.026 g of L-cysteic acid (commercial Ex. 2), when a 1 mol/L cysteic acid solution is used (121.8 g/membrane). After second use the concentration of L-cysteic acid solution (commercial Ex. 2) decreased from 0.82 M to 0.66 M. Based on pH results, it was found that ˜1.00 g of Al₂O₃ membrane uptakes about 0.023 g of L-cysteic acid (commercial Ex. 2), when a 0.82 mol/L cysteic acid solution is used (108.3 g/membrane). As can be seen, the L-cysteic acid uptake results obtained from NMR for (synthesized) and from pH for (commercial Ex. 2) are in a good agreement. This indicated that concentration and uptake of L-cysteic acid in reactor can be monitored by simple pH measurement in comparison to NMR. FIG. 5 depicts a plot of aqueous L-cysteic acid solution pH as a function of reaction time with an alumina membrane.

FIG. 6 shows exemplary data for the pH versus concentration of a solution made of commercial L-cysteic acid (601) and for a L-cysteic acid solution (1 mol/L, made from commercial L-cysteic acid) after reaction with two alumina membranes without replenishing the solution. A linear fit of pH versus concentration of the L-cysteic acid is also shown. After reaction of the L-cysteic acid solution with the first membrane (602), the average pH value of 1.066 gives a concentration of about 0.82 mol/L. Using this number and identifying that the volume used to fill a reactor with loaded membrane was about 4 L and the mass of a membrane is about 4,800 g, one membrane, on average, uptakes about 121.8 g of L-cysteic acid per membrane or about 0.0254 g/g of membrane. After reaction of the L-cysteic acid solution with the second membrane (603), the measured pH is about 1.13 (c_{avg}=˜0.66 mol/L), which is in fact, similar to the concentration of starting L-cysteic acid (synthesized). The observation that the solution stays clear after second reaction over a long period was a good indicator of uptake by a membrane. These results suggested that the functionalization using commercial L-cysteic acid could be more complete than the functionalization using synthesized L-cysteic acid.

Overall, the change in pH as a function of L-cysteic acid concentration does show the expected general trend of decreased pH (more acidic) with increased L-cysteic acid concentrations. However, as shown in FIG. 4, the actual values, and also those of conductivity, can be highly dependent on the source of L-cysteic acid. This in turn makes the measurement of the extent of reaction difficult. It is also seen that the variation between pH and reaction time may not be a linear process as shown in FIG. 5. However, for a particular batch of L-cysteic acid from a specific source, the change in pH from its initial to final level can correlate with the L-cysteic acid consumed as is shown in FIG. 6.

### Flux

As described above, the use of the comparative methods (C.Ex. 1, C.Ex. 2, and C.Ex. 3) to form functionalized membranes results in less than optimum flux for the functionalized membranes. In order to determine the minimum concentration of L-cysteic acid utilized for forming the functionalized membranes for various increases in membrane flux, the water flux of a series of membranes was measured prior to functionalization with a specific concentration of L-cysteic acid. Functionalization was carried out by the method described in Ex. 1 with varying concentrations of L-cysteic acid. The water flux was then measured after functionalization and the percentage increase determined. Water flux was measured at about 1 bar pressure for a run time of 48 hours.

FIG. 7 shows exemplary data of the increase in water flux for an alumina membrane as a function of the initial concentration of the L-cysteic acid aqueous solution used to form the functionalized membrane. In this example, the water flux of an alumina membrane increases with increased L-cysteic acid concentration until about 0.6 mol/L. Further increases in the concentration of L-cysteic acid may not significantly affect the water flux in this example.

Table 2 shows exemplary data for the increase in water flux for a different alumina membrane as a function of the initial L-cysteic acid aqueous solution used to form the functionalized membrane. The data in Table 2 shows that membrane flux can be increased by the initial concentration of the L-cysteic acid aqueous solution. For example, when the initial concentration of the L-cysteic acid aqueous solution was about mol/L, 0.5 mol/L, or about 1 mol/L, the increase in membrane flux was determined to be about 6.6%, 16.8%, and about 20.9%, respectively.

TABLE 2

| | Membrane flux | Membrane flux |
|---|---|---|
| Sample | (Liter/m²/h) | increase (%) |
| Untreated | 446.33 | 6.6 |
| 0.25 mol/L L-cysteic acid | 476 | |
| Untreated | 446 | 16.8 |
| 0.5 mol/L L-cysteic acid | 521 | |
| Untreated | 478 | 20.9 |
| 1 mol/L L-cysteic acid | 578 | |

### Mass of Cysteic Acid per Membrane

Without pre-treatment, the inventors also found that the extent of functionalization can be increased, which increases the water flux through the membrane. For the comparative examples, the highest mass per membrane for a 1.5 m long ceramic membrane was found to be 48.13 g per membrane. In contrast, and as enabled by embodiments described herein, the mass due to functionalization can be increased in some examples to at least about 50 g per membrane, such as at least about 100 g per membrane, such as between about 110.4 and about 121.8 g per membrane using ˜19 hours total treatment time with an initial L-cysteic acid concentration of about mol/L or more. This represents a ˜250% increase in functionalization for the same membranes and without pre-treatment.

Embodiments of the present disclosure generally relate to processes for forming functionalized membranes useful for, e.g., component separation. The processes described herein are less complex than conventional methods, and are free of membrane pre-treatment operations and/or cleaning operations. It has been found that if the membranes are immersed in the L-cysteic acid solution without prior hydration or oxidation, the reaction time can be significantly decreased and a higher mass of hydrophilic agent per membrane can be achieved. Additionally, the functionalized membranes can be formed more quickly and at lower reaction temperatures than conventional methods.

### Embodiments Listing

The present disclosure provides, among others, the following embodiments, each of which can be considered as optionally including any alternate embodiments:

Clause 1. A process for forming a functionalized porous membrane, comprising:

introducing a porous membrane with an aqueous solution of a hydrophilic agent in a reaction zone, the porous membrane comprising aluminum-containing materials, titanium-containing materials, zirconium-containing materials, or combinations thereof, and the hydrophilic agent comprising a hydrophilic carboxylic acid or ion thereof; and

operating the reaction zone under conditions to form the functionalized porous membrane, the conditions comprising heating the reaction zone to a temperature of about 95° C. or less.

Clause 2. The process of Clause 1, wherein a vacuum is applied to the reaction zone after introducing the porous membrane with the aqueous solution and prior to heating the reaction zone.

Clause 3. The process of Clause 1 or Clause 2, wherein a concentration of the hydrophilic agent in the aqueous solution is about 0.5 mol/L or more.

Clause 4. The process of Clause 3, further comprising repeating the operations of claim 1 on one or more of a plurality of different porous membranes until the concentration of the hydrophilic agent in the aqueous solution is less than 0.5 mol/L.

Clause 5. The process of Clause 4, further comprising introducing additional hydrophilic agent to the aqueous solution when the concentration of the hydrophilic agent in the aqueous solution is less than 0.5 mol/L.

Clause 6. The process of Clause 1, wherein the hydrophilic agent comprises cysteic acid, 3,5-diiodotyrosine, trans-fumaric acid, malonic acid, octanoic acid, stearic acid, 3,5-dihydroxybenzoic acid, para-hydroxybenzoic acid, glycine, an ion thereof, or combinations thereof.

Clause 7. The process of Clause 6, wherein the porous membrane comprises Al₂O₃

Clause 8. The process of clause 6, wherein the hydrophilic agent comprises cysteic acid or an ion thereof.

Clause 9. The process of any one of Clauses 1-8, wherein a membrane flux of the functionalized porous membrane is increased by about 20% relative to the porous membrane.

Clause 10. The process of any one of Clauses 1-9, wherein the porous membrane comprises pores having a pore diameter of about 0.1 μm to about 5 μm.

Clause 11. The process of any one of Clauses 1-10, wherein the porous membrane is a tubular crossflow membrane.

Clause 12. A process for forming a functionalized ceramic membrane, comprising:

combining a ceramic membrane and a hydrophilic agent solution in a vessel, the hydrophilic agent solution having a concentration of a hydrophilic agent of about 0.6 mol/L or more;

reducing a pressure of the vessel for a duration of time effective to remove air from the vessel; and

heating the vessel at a temperature from about 80° C. to about 95° C. to form the functionalized ceramic membrane.

Clause 13. The process of Clause 12, wherein the functionalized ceramic membrane comprises a plurality of hydrophilic molecules, wherein the hydrophilic molecules comprise neutral or zwitterionic molecules linked to the ceramic membrane through carboxylic acid groups of the neutral or zwitterionic molecules.

Clause 14. The process of Clause 12 or Clause 13, wherein the hydrophilic agent comprises cysteic acid, an ion thereof, or a combination thereof.

Clause 15. The process of any one of Clauses 12-14, wherein the process is free of a hydration operation or an oxidation operation prior to combining porous ceramic membrane and the hydrophilic agent solution.

Clause 16. The process of any one of Clauses 12-15, wherein heating the vessel from about 80° C. to about 95° C. is performed for about 19 hours or less.

Clause 17. The process of any one of Clauses 12-16, wherein:

the hydrophilic agent comprises cysteic acid or ion thereof and

the ceramic membrane comprises pores having a pore diameter of about 0.1 μm to about 10 μm.

Clause 18. The process of any one of Clauses 12-17, wherein a membrane flux of the functionalized ceramic membrane is increased by about 20% relative to the ceramic membrane.

Clause 19. A process for forming a functionalized ceramic membrane, comprising:

combining a ceramic membrane and a hydrophilic agent solution in a reactor, the hydrophilic agent solution having a concentration of a hydrophilic agent of about 0.5 mol/L to about 0.7 mol/L;

reducing a pressure of the reactor for a duration of time effective to at least partially remove air from the reactor; and

reacting the ceramic membrane and the hydrophilic agent at a temperature below about 100° C. and for a time of less than about 19 h to form the functionalized ceramic membrane.

Clause 20. The process of Clause 19, wherein:

the ceramic membrane comprises aluminum-containing materials, titanium-containing materials, zirconium-containing materials, or combinations thereof;
the hydrophilic agent is selected from the group consisting of cysteic acid, 3,5-diiodotyrosine, trans-fumaric acid, malonic acid, octanoic acid, stearic acid, 3,5-dihydroxybenzoic acid, para-hydroxybenzoic acid, glycine, an ion thereof, and combinations thereof; and
the ceramic membrane comprises pores having a pore diameter of about 0.1 μm or more.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Where isomers of a named molecule group exist (e.g., trans-fumaric acid), reference to one member of the group (e.g., trans-fumaric acid) shall expressly disclose the remaining isomers (e.g., cis-fumaric acid) in the family. Likewise, reference to a named molecule without specifying a particular isomer (e.g., fumaric acid) expressly discloses all isomers (e.g., trans-fumaric acid and cis-fumaric acid). As another example, where isomers of a named molecule group exist (e.g., L-cysteic acid), reference to one member of the group (e.g., L-cysteic acid) shall expressly disclose the remaining isomers (e.g., R-cysteic acid) in the family. Likewise, reference to a named molecule without specifying a particular isomer (e.g., cysteic acid) expressly discloses all isomers (e.g., L-cysteic acid and R-cysteic acid).

As used herein, the indefinite article “a” or “an” shall mean “at least one” unless specified to the contrary or the context clearly indicates otherwise.

While the foregoing is directed to aspects of the present disclosure, other and further embodiments of the disclosure may be devised without departing from the basic scope thereof, and the scope thereof is determined by the claims that follow.

What is claimed is:

1. A process for forming a functionalized porous membrane, comprising:
introducing a porous membrane with an aqueous solution of a hydrophilic agent in a reaction zone, the porous membrane comprising aluminum-containing materials, titanium-containing materials, zirconium-containing materials, or combinations thereof, and the hydrophilic agent comprising a hydrophilic carboxylic acid or ion thereof; and
operating the reaction zone under conditions to form a functionalized porous membrane, the conditions comprising heating the reaction zone to a temperature of about 95° C. or less.

2. The process of claim 1, wherein a vacuum is applied to the reaction zone after introducing the porous membrane with the aqueous solution and prior to heating the reaction zone.

3. The process of claim 1, wherein a concentration of the hydrophilic agent in the aqueous solution is about 0.5 mol/L or more.

4. The process of claim 3, further comprising:
repeating the operations of claim 1 on one or more of a plurality of different porous membranes until the concentration of the hydrophilic agent in the aqueous solution is less than 0.5 mol/L.

5. The process of claim 4, further comprising:
introducing additional hydrophilic agent to the aqueous solution when the concentration of the hydrophilic agent in the aqueous solution is less than 0.5 mol/L.

6. The process of claim 1, wherein the hydrophilic agent comprises cysteic acid, 3,5-diiodotyrosine, trans-fumaric acid, malonic acid, octanoic acid, stearic acid, 3,5-dihydroxybenzoic acid, para-hydroxybenzoic acid, glycine, an ion thereof, or combinations thereof.

7. The process of claim 6, wherein the porous membrane comprises Al₂O₃.

8. The process of claim 6, wherein the hydrophilic agent comprises cysteic acid or an ion thereof.

9. The process of claim 1, wherein a membrane flux of the functionalized porous membrane is increased by about 20% relative to the porous membrane.

10. The process of claim 1, wherein the porous membrane comprises pores having a pore diameter of about 0.1 μm to about 5 μm.

11. The process of claim 1, wherein the porous membrane is a tubular crossflow membrane.

12. A process for forming a functionalized ceramic membrane, comprising:
combining a ceramic membrane and a hydrophilic agent solution in a vessel, the hydrophilic agent solution having a concentration of a hydrophilic agent of about 0.6 mol/L or more;
reducing a pressure of the vessel for a duration of time effective to remove air from the vessel; and
heating the vessel at a temperature from about 80° C. to about 95° C. to form the functionalized ceramic membrane.

13. The process of claim 12, wherein the functionalized ceramic membrane comprises a plurality of hydrophilic molecules, wherein the hydrophilic molecules comprise neutral or zwitterionic molecules linked to the ceramic membrane through carboxylic acid groups of the neutral or zwitterionic molecules.

14. The process of claim 12, wherein the hydrophilic agent comprises cysteic acid, an ion thereof, or a combination thereof.

15. The process of claim 12, wherein the process is free of a hydration operation or an oxidation operation prior to combining porous ceramic membrane and the hydrophilic agent solution.

16. The process of claim 12, wherein heating the vessel from about 80° C. to about 95° C. is performed for about 19 hours or less.

17. The process of claim 12, wherein:
the hydrophilic agent comprises cysteic acid or ion thereof; and
the ceramic membrane comprises pores having a pore diameter of about 0.1 μm to about 10 μm.

18. The process of claim 12, wherein a membrane flux of the functionalized ceramic membrane is increased by about 20% relative to the ceramic membrane.

19. A process for forming a functionalized ceramic membrane, comprising:
combining a ceramic membrane and a hydrophilic agent solution in a reactor, the hydrophilic agent solution having a concentration of a hydrophilic agent of about 0.5 mol/L to about 0.7 mol/L;
reducing a pressure of the reactor for a duration of time effective to at least partially remove air from the reactor; and
reacting the ceramic membrane and the hydrophilic agent at a temperature below about 100° C. and for a time of less than about 19 h to form the functionalized ceramic membrane.

20. The process of claim 19, wherein:
the ceramic membrane comprises aluminum-containing materials, titanium-containing materials, zirconium-containing materials, or combinations thereof;
the hydrophilic agent is selected from the group consisting of cysteic acid, 3,5-diiodotyrosine, trans-fumaric acid, malonic acid, octanoic acid, stearic acid, 3,5-dihydroxybenzoic acid, para-hydroxybenzoic acid, glycine, an ion thereof and combinations thereof; and
the ceramic membrane comprises pores having a pore diameter of about 0.1 μm or more.
